(19) United States
(12) Patent Application Publication
(10) Pub. No.: US 2008/0043053 A1
(43) Pub. Date: Feb. 21, 2008

(54) RECORDING APPARATUS AND PULSE GENERATION CONTROLLER

(76) Inventor: Katsuaki Suzuki, Gifu-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(21) Appl. No.: 11/840,295

(22) Filed: Aug. 17, 2007

(30) Foreign Application Priority Data
Aug. 21, 2006 (JP) 2006224047

(51) Int. Cl. B41J 29/38

(52) U.S. Cl. 347/17

(57) ABSTRACT

A recording apparatus of the present invention includes a temperature detector which detects a temperature of a pulse generator, and a driver which drives the pulse generator. When the temperature detector detects a temperature equal to or higher than a predetermined maximum temperature, a stopper stops a driver after driving of the pulse generator corresponding to one or a plurality of driving units is completed. A temperature estimator estimates an increased temperature of the pulse generator based on a pulse pattern which will be generated by the pulse generator thus driven again. A restarter makes the driver restart driving the pulse generator when, after the driver is stopped, a temperature detected by the temperature detector drops to a restart temperature which is equal to or lower than a temperature value obtained by subtracting the increased temperature from the maximum temperature.

### CROSS REFERENCE TO RELATED APPLICATION

The present application claims priority from Japanese Patent Application No. 2006-224047, which was filed on Aug. 21, 2006, the disclosure of which is herein incorporated by reference in its entirety.

### BACKGROUND OF THE INVENTION

1. Field of the Invention

The present invention relates to a recording apparatus which records an image on a recording medium, and also relates to a pulse generation controller.

2. Description of Related Art

Known is an ink-jet printer which ejects ink droplets on a recording paper as a recording medium to thereby print an image on the recording paper. As such an ink-jet printer, one including a recording head and a driver IC is known. The recording head includes a passage unit and an actuator. The passage unit has nozzles which eject ink droplets, and pressure chambers which communicate with the nozzles. The actuator applies ejection energy to ink contained in the pressure chambers. The driver IC generates a pulse pattern for driving the actuator. The actuator applies pressure to a pressure chamber by changing a volume of the pressure chamber. The actuator includes a piezoelectric sheet which extends over a plurality of pressure chambers, a plurality of individual electrodes which are opposed to the respective pressure chambers, and a common electrode which is opposed to the plurality of individual electrodes with the piezoelectric sheet sandwiched therebetween and to which a reference potential is applied. A pulsed drive signal is applied from the driver IC to an individual electrode of the actuator so that an electric field in a thickness direction of the piezoelectric sheet occurs in a portion of the piezoelectric sheet sandwiched between this individual electrode and the common electrode. As a result, this portion of the piezoelectric sheet deforms. This changes a volume of a corresponding pressure chamber, and accordingly pressure is applied to ink contained in the pressure chamber.

A higher-speed printing is now demanded of an ink-jet printer. Shortening an ejection cycle of an ink droplet for the purpose of a higher-speed printing involves increasing a pulse frequency which is outputted from a driver IC. However, if a driver IC continuously outputs high-frequency pulses, the driver IC generates a large amount of heat and increases in temperature. Japanese Unexamined Patent Publication No. 2004-25512 discloses that, in order to prevent a thermal destruction of a driver IC which has reached a high temperature, a printing is stopped to cool down the driver IC when a temperature of the driver IC becomes equal to or higher than a predetermined maximum temperature and then the printing is started again after the temperature of the driver IC drops to a predetermined restart temperature.

### SUMMARY OF THE INVENTION

In an ink-jet printer as described above, once a printing starts, a pulse pattern output from the driver IC is unstoppable for a predetermined period of time. For example, in a case where a recording head is a line-type head having an ink ejection face extending in a direction perpendicular to a recording medium conveyance direction, the predetermined period of time means a period of time corresponding to a driving unit which is a unit of recording in a printing operation performed on respective print regions of a recording paper which are spaced from each other by a margin with respect to the conveyance direction. In a case where a recording head is a serial-type head which scans in a direction perpendicular to a recording medium conveyance direction, the predetermined period of time means a period of time corresponding to a driving unit which is a unit of recording in a printing operation with an arbitrary number of scannings. That is, if a printing once started is stopped during the above-described predetermined period of time, an image formed on a recording paper deteriorates. It is therefore necessary to determine a restart temperature in such a manner that a temperature of a driver IC does not largely exceed the maximum temperature even when, after a printing is started again, a printing operation corresponding to a next driving unit is completed, that is, even when a temperature of a driver IC becomes highest. However, if a restart temperature is determined so as to make a temperature of the driver IC sufficiently lower than the maximum temperature even when a printing operation corresponding to a next driving unit is completed, the driver IC needs to stay stopped too much. As a result, a total printing speed is lowered in a case where a printing operation including a plurality of continuous driving units is performed.

An object of the present invention is to provide a recording apparatus and a pulse generation controller which can suppress lowering of total recording speed in a case where a recording including a plurality of continuous driving units is performed.

According to a first aspect of the present invention, there is provided a recording apparatus comprising a recording head, a pulse generator, a temperature detector, a driver, a stopper, a temperature estimator, and a restarter. The recording head records an image on a recording medium. The pulse generator generates a pulse pattern for driving the recording head. The temperature detector detects a temperature of the pulse generator. The driver drives the pulse generator under a condition that the pulse generator is driven per driving unit which corresponds to a recording unit pertaining to a recording of the image. When the temperature detector detects a temperature equal to or higher than a predetermined maximum temperature, the stopper stops the driver after driving of the pulse generator corresponding to one or a plurality of driving units is completed. The temperature estimator estimates a temperature of the pulse generator increased when the pulse generator is driven again by the driver, based on a pulse pattern which will be generated by the pulse generator thus driven again, on an assumption that the stopped driver is driven again and drives the pulse generator for a period of time corresponding to one or a plurality of driving units. The restarter makes the driver restart driving the pulse generator when, after the driver is stopped, a temperature of the pulse generator detected by the temperature detector drops to a restart temperature which is equal to or lower than a temperature value obtained by subtracting the increased temperature from the maximum temperature.

According to a second aspect of the present invention, there is provided a pulse generation controller comprising a pulse generator, a temperature detector, a driver, a stopper, a temperature estimator, and a restarter. The pulse generator generates a pulse pattern. The temperature detector detects a temperature of the pulse generator. The driver drives the pulse generator under a condition that a driving unit is a processing in which the pulse pattern should be generated without a stop. When the temperature detector detects a temperature equal to or higher than a predetermined maximum temperature, the stopper stops the driver after driving of the pulse generator corresponding to one or a plurality of driving units is completed. The temperature estimator estimates a temperature of the pulse generator increased when the pulse generator is driven again by the driver, based on a pulse pattern which will be generated by the pulse generator thus driven again, on an assumption that the stopped driver is driven again and drives the pulse generator for a period of time corresponding to one or a plurality of driving units. The restarter makes the driver restart driving the pulse generator when, after the driver is stopped, a temperature of the pulse generator detected by the temperature detector drops to a restart temperature which is equal to or lower than a temperature value obtained by subtracting the increased temperature from the maximum temperature.

Here, the “driving unit” mentioned in the first and second aspects corresponds to a period of time during which the recording head which moves relative to the recording medium is opposed to the recording medium or a recording region of the recording medium.

According to the first and second aspects, the temperature estimator estimates an increased temperature of the pulse generator based on a next pulse pattern which will be generated by the pulse generator, and the restarter determines, based on the increased temperature, a restart temperature at which the pulse generator will be driven again. This can prevent the pulse generator from being stopped too much. In the recording apparatus according to the first aspect, in a case where a recording is performed through a plurality of continuous driving units, lowering of a total recording speed can be suppressed while not stopping generation of the pulse pattern during a period of time corresponding to a driving unit.

### BRIEF DESCRIPTION OF THE DRAWINGS

Other and further objects, features and advantages of the invention will appear more fully from the following description taken in connection with the accompanying drawings in which:

FIG. 1 is a side view of an appearance of an ink-jet head according to an embodiment of the present invention;

FIG. 2 is a sectional view taken along a widthwise direction of the ink-jet head shown in FIG. 1;

FIG. 3 is a plan view of a head main body shown in FIG. 2;

FIG. 4 is an enlarged view of a region enclosed by an alternate long and short dash line in FIG. 3;

FIG. 5 is a sectional view taken along line V-V in FIG. 4;

FIG. 6A is a sectional view on an enlarged scale of an actuator unit shown in FIG. 4;

FIG. 6B is a plan view of an individual electrode which is placed on a surface of the actuator unit in FIG. 6A;

FIG. 7 is a functional block diagram of a control unit shown in FIG. 1;

FIG. 8 shows a waveform of a drive signal which is outputted from a driver IC shown in FIG. 2;

FIG. 9 is a flowchart showing an operation of the control unit shown in FIG. 1;

FIG. 10 is a graph showing a change in temperature of the driver IC shown in FIG. 2; and

FIG. 11 is a graph showing a change in temperature of a driver IC according to a modification.

### DESCRIPTION OF THE PREFERRED EMBODIMENTS

In the following, a certain preferred embodiment of the present invention will be described with reference to the accompanying drawings.

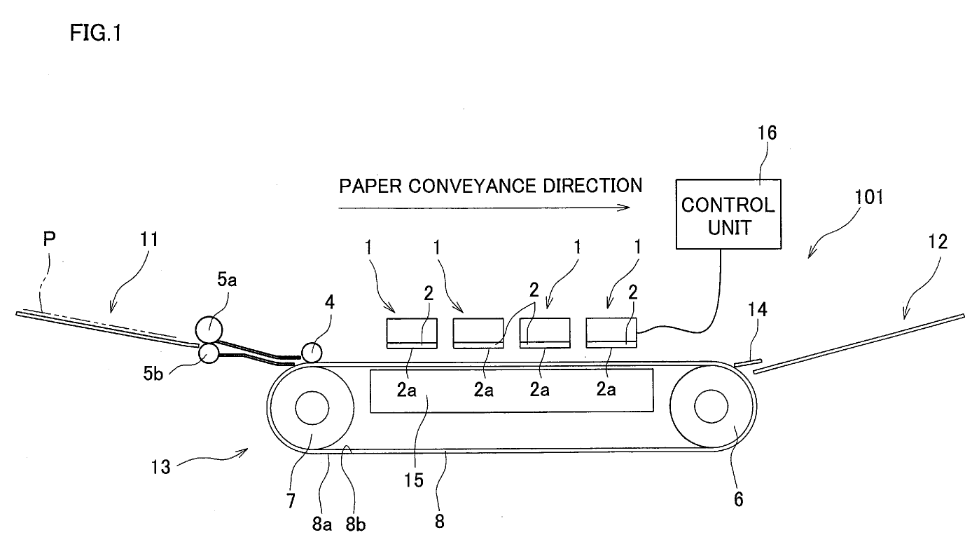

FIG. 1 is a schematic side view showing a general construction of an ink-jet printer which is one preferred embodiment of the present invention. As shown in FIG. 1, an ink-jet printer 101 which is a recording apparatus is a color ink-jet printer having four ink-jet heads 1. The ink-jet printer 101 has a control unit 16 which controls a whole of the ink-jet printer 101 and in addition functions as a pulse generation controller. The ink-jet printer 101 includes a paper feed unit 11 and a paper discharge unit 12, which are shown in left and right parts of FIG. 1, respectively.

Formed within the ink-jet printer 101 is a paper conveyance path through which a paper P as a recording medium is conveyed from the paper feed unit 11 toward the paper discharge unit 12. A pair of feed rollers 5a and 5b, which pinches a paper therebetween and conveys the paper, is disposed near the paper feed unit 11. The pair of feed rollers 5a and 5b serves to send out a paper P from the paper feed unit 11 to a right side in FIG. 1. A belt conveyor mechanism 13 is provided in a middle of the paper conveyance path. The belt conveyor mechanism 13 is a conveyor mechanism including two belt rollers 6 and 7, an endless conveyor belt 8, and a platen 15. The endless conveyor belt 8 is wound on and stretched between the rollers 6 and 7. The platen 15 is disposed in a region enclosed by the conveyor belt 8, so as to be opposed to the ink-jet heads 1. The platen 15 supports the conveyor belt 8 to prevent a portion of the conveyor belt 8 opposed to the ink-jet heads 1 from being bent downward. A nip roller 4 is disposed at a position opposed to the belt roller 7. The nip roller 4 presses a paper P, which has been sent out of the paper feed unit 11 by the feed rollers 5a and 5b, to an outer circumferential surface 8a of the conveyor belt 8.

As a conveyor motor (not shown) makes the belt roller 6 rotate, the conveyor belt 8 is driven. The conveyor belt 8 conveys the paper P, which has been pressed to the outer circumferential surface 8a by the nip roller 4, toward the paper discharge unit 12 while keeping the paper P by its adhesive force. Like this, the conveyor mechanism which conveys a paper P is made up of the conveyor belt 8, the belt rollers 6 and 7, and the conveyor motor which makes the belt roller 6 rotate.

A peeling mechanism 14 is provided between the conveyor belt 8 and the paper discharge unit 12 in the paper conveyance direction. The peeling mechanism 14 peels a paper P, which has been adhered to the outer circumferential surface 8a of the conveyor belt 8, from the outer circumferential surface 8a, and then sends the paper P to the rightward paper discharge unit 12.

The four ink-jet heads 1 correspond to ink of four colors, namely, magenta ink, yellow ink, cyan ink, and black ink, respectively. The four ink-jet heads 1 are arranged side by side along the conveyance direction of the paper P. Thus, the ink-jet printer 101 is a line-type printer. Each of the four ink-jet heads 1 has, at its lower end, a head main body 2. The head main body 2 has a rectangular parallelepiped shape elongated in a direction perpendicular to the conveyance direction. A bottom face of the head main body 2 serves as an ink ejection face 2a which is opposed to the outer circumferential surface 8a of the conveyor belt 8. While a paper P being conveyed on the conveyor belt 8 is sequentially passing just under the four head main bodies 2, ink droplets of respective colors are ejected from the ink ejection faces 2a toward a print region formed on an upper face of the paper P, that is, a print face of the paper P. Thereby, a desired color image can be formed in the print region of the paper P.

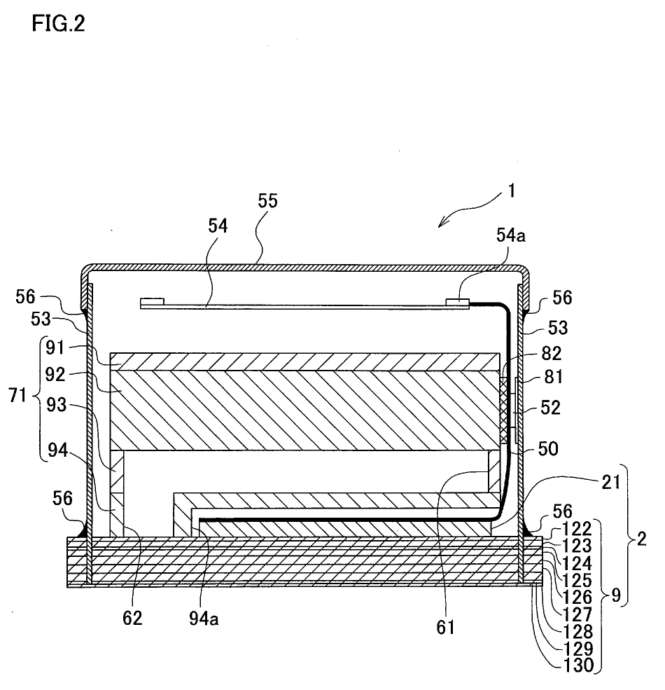

Next, with reference to FIG. 2, a detailed description will be given to the ink-jet head 1. FIG. 2 is a sectional view taken along a widthwise direction of the ink-jet head 1. As shown in FIG. 2, the ink-jet head 1 has a head main body 2, a reservoir unit 71, a COF (Chip On Film) 50, and a circuit board 54. The head main body 2 is a recording head including a passage unit 9 and actuator units 21. The reservoir unit 71 is disposed on an upper face of the head main body 2, and supplies ink to the head main body 2. The COF 50 has a driver IC 52 mounted on a surface thereof. The driver IC 52 is a pulse generator which generates a drive signal for driving the actuator unit 21. The circuit board 54 is electrically connected to the COF 50. The ink-jet head 1 also includes side covers 53 and a head cover 55 which cover the actuator units 21, the reservoir unit 71, the COF 50, and the circuit board 54, to prevent intrusion of ink or ink mist from outside.

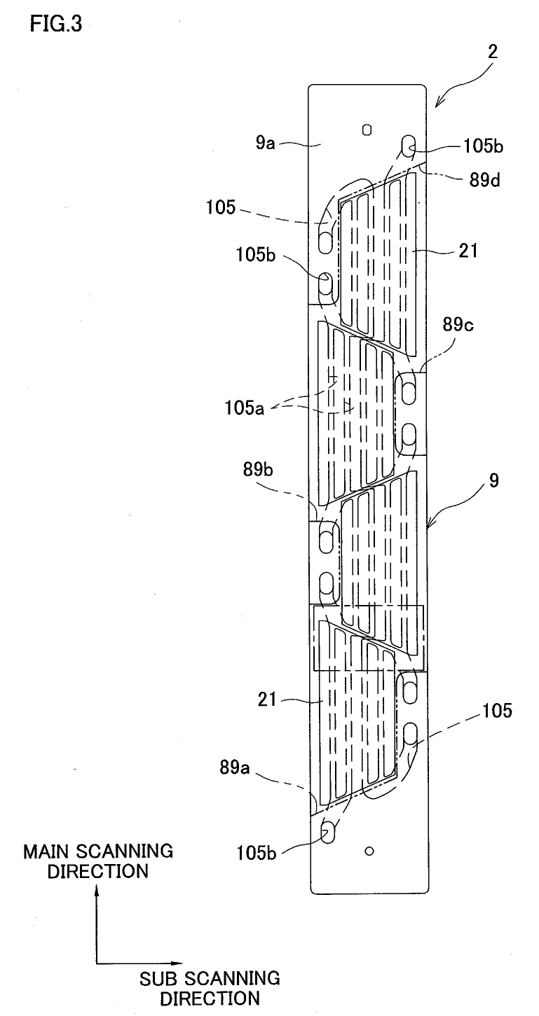

The reservoir unit 71 is made up of four plates 91 to 94 positioned in layers to each other. Within the reservoir unit 71, an ink inflow passage (not shown), an ink reservoir 61, and ten ink outflow passages 62 are formed so as to communicate with each other. FIG. 2 illustrates only one of the ink outflow passages 62. Ink flows from an ink tank (not shown) into the ink inflow passage. The ink reservoir 61 communicates with the ink inflow passage and the ink outflow passages 62. The ink outflow passages 62 communicate with the passage unit 9 through ink supply ports 105 (see FIG. 3) which are formed on an upper face of the passage unit 9. Ink supplied from the ink tank flows through the ink inflow passage into the ink reservoir 61. The ink having flown into the ink reservoir 61 passes through the ink outflow passages 62, to be supplied to the passage unit 9 through the ink supply ports 105b.

A recess 94a is formed in the plate 94. There is a space between the passage unit 9 and a portion of the plate 94 in which the recess 94a is formed. The actuator units 21 are positioned in the space.

The COF 50 is, in a portion near one end thereof, bonded to an upper face of the actuator unit 21 in such a manner that wires (not shown) formed on a surface of the COF 50 are electrically connected to individual electrodes 135 and a common electrode 134 which will be described later. The COF 50 extends from the upper face of the actuator unit 21 upward through a space between the side cover 53 and the reservoir unit 71, to have the other end thereof connected to the circuit board 54 through the connector 54a.

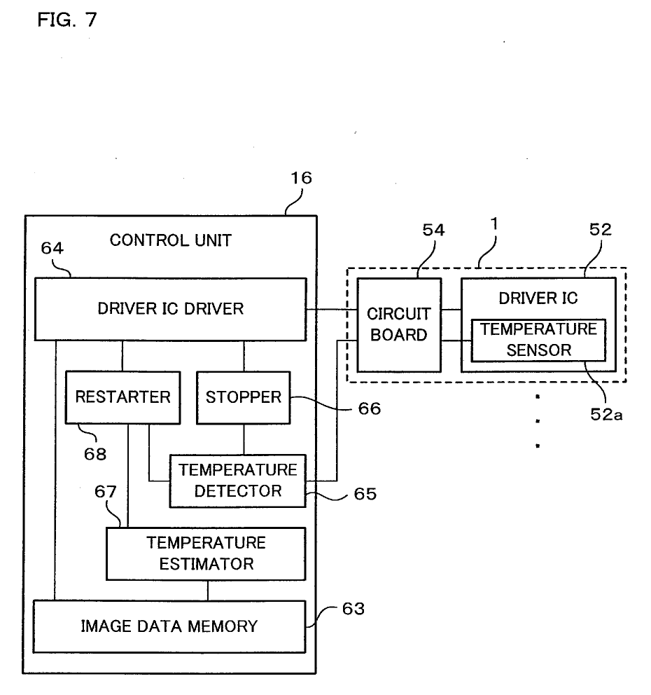

The driver IC 52 outputs a drive signal through a wire of the COF 50 to each individual electrode 135 of the actuator unit 21. The driver IC 52 has a temperature sensor 52a (see FIG. 7) which detects a temperature of the driver IC 52. The driver IC 52 is biased to the side cover 53 by a sponge 82 which is bonded to a side face of the reservoir unit 71. The driver IC 52 is in tight contact with an inside face of the side cover 53 with a dissipation sheet 81 sandwiched therebetween. Thereby, the driver IC 52 is thermally coupled with the side cover 53. Consequently, heat of the driver IC 52 is dissipated through the side cover to outside.

Based on a command from the control unit 16, the circuit board 54 makes the driver IC 52 of the COF 50 output a drive signal to the actuator unit 21, thereby driving the actuator unit 21.

The side covers 53 are metallic plate members, and extend upward from both widthwise end portions of the upper face of the passage unit 9. The head cover 55 is mounted over the side covers 53 so as to seal a space above the passage unit 9. Like this, the reservoir unit 71, the COF 50, and the circuit board 54 are placed within a space which is enclosed by the two side covers 53 and the head cover 55. Sealing members 56 made of a silicon resin or the like are applied to where the side cover 53 and the passage unit 9 are connected to each other, and where the side cover 53 and the head cover 55 are fitted to each other. Thereby, intrusion of ink or ink mist from outside is more surely prevented.

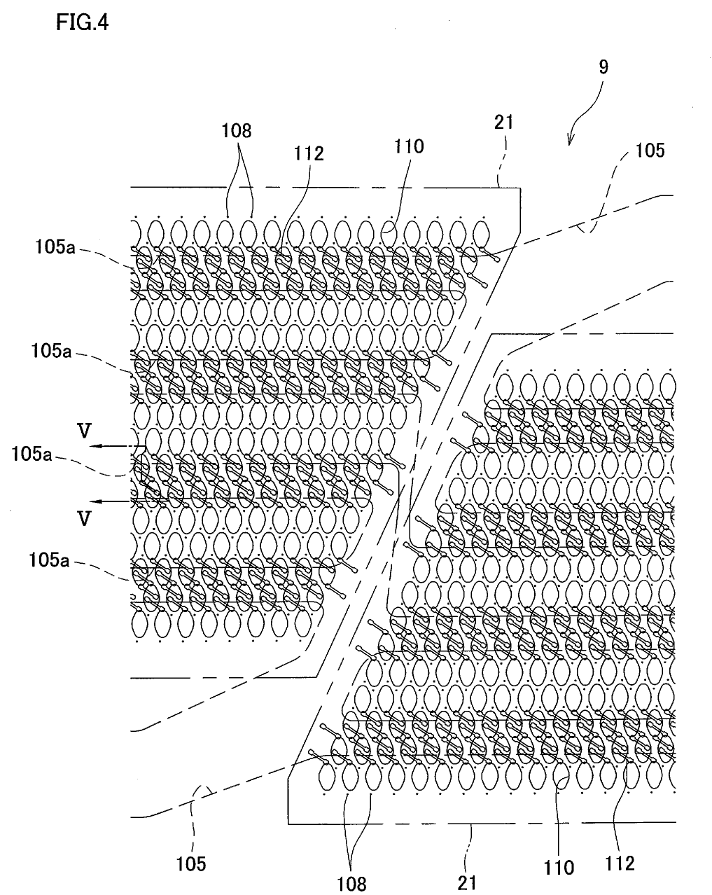

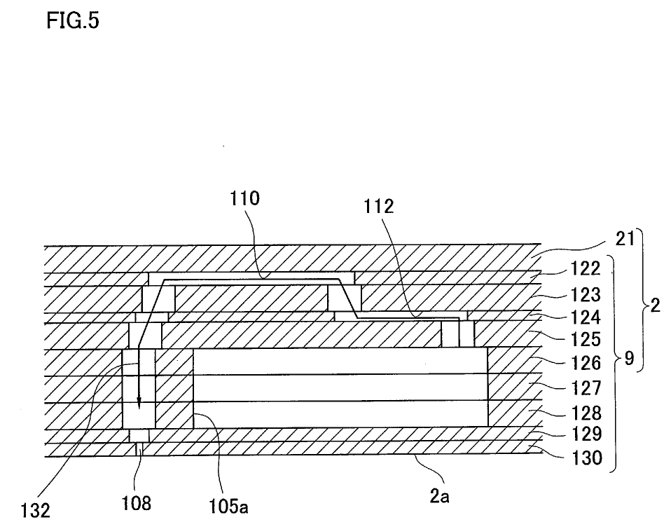

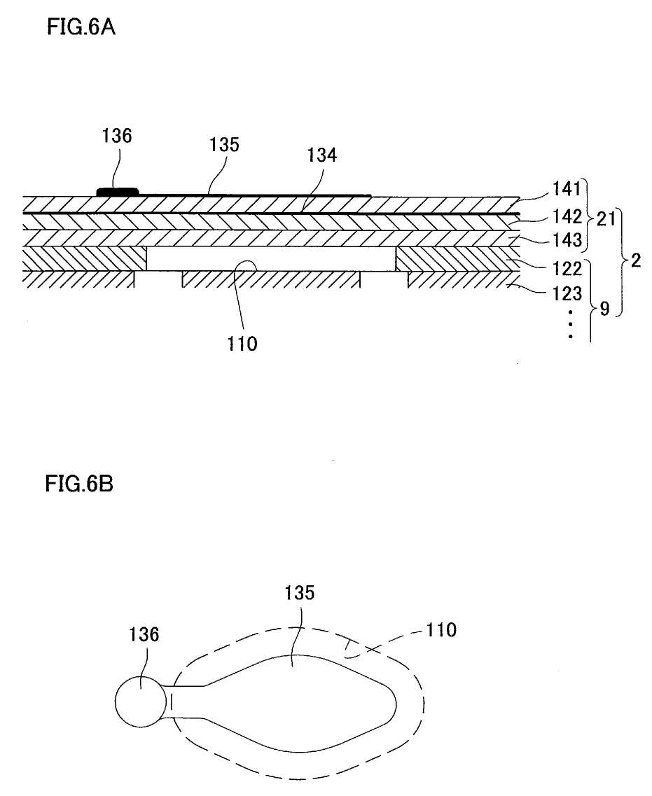

Next, the head main body 2 will be described with reference to FIGS. 3 to 6. FIG. 3 is a plan view of the head main body 2. FIG. 4 is an enlarged view of a region enclosed by an alternate long and short dash line in FIG. 3. In FIG. 4, for convenience of explanation, pressure chambers 110, apertures 112, and nozzles 108 are illustrated with solid lines although they locate below the actuator units 21 and therefore should actually be illustrated with broken lines. FIG. 5 is a sectional view taken along line V-V in FIG. 4. FIG. 6A is a sectional view on an enlarged scale of the actuator unit 21, and FIG. 6B is a plan view of an individual electrode which is placed on the surface of the actuator unit 21 as shown in FIG. 6A.

As shown in FIG. 3, the head main body 2 includes a passage unit 9 and four actuator units 21 fixed to an upper face 9a of the passage unit 9. As shown in FIG. 4, the actuator unit 21 includes a plurality of actuators which are opposed to the respective pressure chambers 110 formed in the passage unit 9. The actuator unit 21 functions to selectively apply ejection energy to ink contained in the pressure chambers 110.

The passage unit 9 has a rectangular parallelepiped shape. In a plan view, the passage unit 9 has a shape slightly larger than that of the plate 94 of the reservoir unit 71. A total of ten ink supply ports 105b are opened on the upper face 9a of the passage unit 9. The ten ink supply ports 105b correspond to the ink outflow passages 62 of the reservoir unit 71 (see FIG. 2). Formed within the passage unit 9 are manifold channels 105 which communicate with the ink supply ports 105b and sub manifold channels 105a which branch from the manifold channels 105. A lower face of the passage unit 9 has an ink ejection region 2a in which a plurality of nozzles 108 are arranged in a matrix, as shown in FIGS. 4 and 5. On a face of the passage unit 9 fixed to the actuator unit 21, a plurality of pressure chambers 110 are arranged in a matrix like the nozzles 108.

In this embodiment, sixteen pressure chamber rows are arranged in parallel with each other with respect to a widthwise direction of the passage unit 9. Each of the pressure chamber rows is made up of pressure chambers 110 which are arranged at regular intervals in a lengthwise direction of the passage unit 9. The number of pressure chambers 110 included in each pressure chamber row is gradually reduced from a longer side to a shorter side of the actuator unit 21, so as to follow an outer shape of the actuator unit 21 which is a trapezoid as will be described later. Nozzles 108 are arranged in the same manner.

As shown in FIG. 5, the passage unit 9 includes nine metal plates such as stainless steel plates, namely, from the top, a cavity plate 122, a base plate 123, an aperture plate 124, a supply plate 125, manifold plates 126, 127, 128, a cover plate 129, and a nozzle plate 130. In a plan view, each of the plates 122 to 130 has a rectangular shape elongated in the main scanning direction.

Formed in the cavity plate 122 are through holes which correspond to the ink supply ports 105b (see FIG. 3), and a plurality of substantially rhombic through holes which correspond to pressure chambers 110. Formed in the base plate 123 are connection holes each connecting each pressure chamber 110 to a corresponding aperture 12. Formed in the aperture plate 124 are through holes which serve as apertures 112 in relation to the respective pressure chambers 110. Formed in the supply plate 125 are connection holes each connecting each aperture 112 to a corresponding sub manifold channel 105a in relation to the respective pressure chambers 110. Formed in the manifold plates 126, 127, and 128 are through holes which will combine into the manifold channels 105 and the sub manifold channels 105a when the plates are put in layers. Formed in the nozzle plate 130 are holes which correspond to the nozzles 108 in relation to the respective pressure chambers 110. In addition, connection holes each connecting each pressure chamber 110 to a corresponding nozzle 108 are formed in the respective plates 123 to 129. Moreover, connection holes (not shown) each connecting an ink supply port 105b to a corresponding manifold channel 105 are formed in the respective plates 123 to 125.

The plates 122 to 130 are positioned in layers, so that a plurality of individual ink passages 132 are formed within the passage unit 9. Each of the individual ink passages 132 extends from a manifold channel 105 to a nozzle 108 through a sub manifold channel 105a, an exit of the sub manifold channel 105a, and a pressure chamber 110.

Next, a description will be given to how ink flows within the passage unit 9. As shown in FIGS. 3 to 5, ink is supplied from the reservoir unit 71 through the ink supply ports 105b into the passage unit 9, and then branched from the manifold channels 105 into the sub manifold channels 105a. Ink in the sub manifold channels 105a flows into the respective individual ink passages 132, goes through apertures 112 acting as throttles and pressure chambers 110, and then reaches the nozzles 108.

The actuator unit 21 will be described. As shown in FIG. 3, four actuator units 21, each of which has a trapezoidal shape in a plan view, are arranged in a zigzag pattern so as to keep away from the ink supply ports 105b. Parallel opposed sides of each actuator unit 21 extend along the lengthwise direction of the passage unit 9. Oblique sides of every neighboring actuator units 21 overlap each other with respect to the widthwise direction of the passage unit 9, that is, with respect to the sub scanning direction.

As shown in FIG. 6A, the actuator unit 21 is made up of piezoelectric sheets 141 to 143 which are three piezoelectric layers made of a lead zirconate titanate (PZT)-base ceramic material having ferroelectricity. On the uppermost piezoelectric sheet 141, individual electrodes 135 are formed at positions opposed to the respective pressure chambers 110. A common electrode 134 which is a ground electrode is interposed between the uppermost piezoelectric sheet 141 and the piezoelectric sheet 142 disposed under the piezoelectric sheet 141. The common electrode 134 is formed over entire opposing surfaces of the respective piezoelectric sheets 141 and 142. As shown in FIG. 6B, in a plan view, the individual electrode 135 has a substantially rhombic shape similar to that of the pressure chamber 110. The substantially rhombic individual electrode 135 has its one acute portion extending out, and a circular land 136 is provided on a distal end of an extending-out portion thus formed. The land 136 is electrically connected to the individual electrode 135.

The common electrode 134 is, in its regions corresponding to all the pressure chambers 110, equally kept at the ground potential which is a reference potential. Each individual electrode 135 is electrically connected to each terminal of the driver IC 52 through a land 136 and an internal wire of the COF 50, so that a drive signal from the driver IC 52 is selectively inputtable to the individual electrode 135. That is, a portion of the actuator unit 21 sandwiched between an individual electrode 135 and a pressure chamber 110 acts as an individual actuator. Thus, the number of actuators formed in the actuator unit 21 corresponds to the number of pressure chambers 110.

Here, how the actuator unit 21 drives will be described. The piezoelectric sheet 141 is polarized in its thickness direction. When an individual electrode 135 is set at a potential different from a potential of the common electrode 134, an electric field in a polarization direction is applied to the piezoelectric sheet 141. As a result, a portion of the piezoelectric sheet 141 to which the electric field is applied acts as an active portion which causes strain due to a piezoelectric effect. That is, the actuator unit 21 is of so-called unimorph type, in which the upper one piezoelectric sheet 141 most distant from the pressure chambers 110 works as a layer including active portions while the lower two piezoelectric sheets 142 and 143 closer to the pressure chambers 110 work as inactive layers. The piezoelectric sheets 141 to 143 are fixed to an upper face of the cavity plate 122 which partitions the pressure chambers 110 as shown in FIG. 6A. Accordingly, a difference occurs between plane-direction strain of the portion of the piezoelectric sheet 141 to which the electric field is applied and plane-direction strain of the lower piezoelectric sheets 142 and 143. This causes a unimorph deformation in which the piezoelectric sheets 141 to 143 as a whole protrude toward a pressure chamber 110 side. Consequently, pressure, that is, ejection energy, is applied to ink contained in the pressure chamber 110, thus causing a pressure wave in the pressure chamber 110. The pressure wave propagates from the pressure chamber 110 to a nozzle 108, thereby ejecting an ink droplet from the nozzle 108.

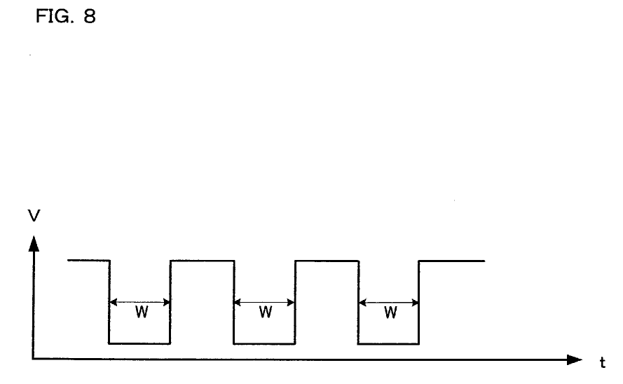

In this embodiment, a predetermined potential has been in advance applied to an individual electrode 135. Upon every ejection request, the driver IC 52 outputs a drive signal which once applies the ground potential to the individual electrode 135 and then at a predetermined timing applies the predetermined potential again to the individual electrode 135 (see FIG. 8). In such a case, at a timing of giving the ground potential to the individual electrode 135, pressure of ink in a corresponding pressure chamber 110 drops so that ink is sucked from a sub manifold channel 105a into an individual ink passage 132. Then, at a timing of giving the predetermined potential again to the individual electrode 135, pressure of ink in the pressure chamber 110 rises so that an ink droplet is ejected from a corresponding nozzle 108. That is, a rectangular wave pulse is applied to the individual electrode 135. A pulse width W is an AL (Acoustic Length) which is a time required for a pressure wave in a pressure chamber 110 to propagate from an exit of the sub manifold channel 105a to a distal end of the nozzle 108. At a time when a state of ink contained in the pressure chamber 110 is reversed from a negative pressure state to a positive pressure state, both pressures are superimposed on each other, and therefore an ink droplet can be ejected from a nozzle 108 under high pressure.

Next, the control unit 16 will be described in detail with reference to FIG. 7. FIG. 7 is a functional block diagram of the control unit 16. FIG. 7 schematically illustrates only one of the four ink-jet heads 1. As shown in FIG. 7, the control unit 16 includes an image data memory 63, a driver IC driver 64 which functions as a driver, a temperature detector 65, a stopper 66, a temperature estimator 67, and a restarter 68. The image data memory 63 stores therein image data concerning an image to be formed on a paper P. The image data is transferred from a host computer (not shown) such as a personal computer. In accordance with a command from the host computer, the driver IC driver 64 drives the driver IC 52 of each ink-jet head 1 through the circuit board 54, in such a manner that an image concerning the image data stored in the image data memory 63 is formed on the paper P. Here, the driver IC driver 64 drives the driver IC 52 under a condition that one driving unit is a unit of recording in a printing operation for forming an image on one paper P. That is, the driving unit mentioned in this embodiment corresponds to a period of time during which the paper P conveyed by the belt conveyor mechanism 13 is opposed to the ink-jet heads 1, in other words, a time interval from when a leading edge of the paper P starts to be opposed to the ink-jet heads 1 to when a trailing edge of the paper P gets no longer opposed to the ink-jet heads 1.

Here, a waveform of a drive signal outputted from the driver IC 52 will be described with reference to FIG. 8. FIG. 8 shows a waveform of a drive signal which is outputted from the driver IC 52 in one printing cycle. Here, a printing cycle means a time required for a paper P to be conveyed by a unit distance which corresponds to a printing resolution of an image to be formed on the paper P. In this embodiment, a printing resolution is 600 dpi. The driver IC 52 outputs a drive signal having an ejection waveform, that is, pulse pattern, in accordance with a command from the driver IC driver 64. The ejection waveform includes a series of pulses corresponding to the number of ink droplets which will be ejected from a nozzle 108 in one printing cycle. A tone of each dot, which constitutes an image to be formed on the paper P, is expressed by an ink ejection amount. The ink ejection amount is controlled by the number of ink droplets ejected from the nozzle 108 in one printing cycle. Therefore, there are a plurality of kinds of ejection waveforms depending on an ink ejection amount which means the number of ink droplets ejected from the nozzle 108 in one printing cycle. In this embodiment, there are three kinds of ejection waveform in total, because one to three droplets is/are ejected from the nozzle 108 in one printing cycle. FIG. 8 shows an ejection waveform for ejecting three ink droplets from the nozzle 108 in one printing cycle. The driver IC 52 generates heat by outputting a drive signal having an ejection waveform. The driver IC 52 generates a larger amount of heat as the number of ink droplets ejected from the nozzle 108 in one printing cycle increases, that is, as a duty ratio of an ejection waveform of a drive signal, which means a ratio of total pulse widths W of respective pulses to the printing cycle, increases.

Referring to FIG. 7 again, the temperature detector 65 detects a temperature T of, among the driver ICs 52, a driver IC 52 having a highest temperature, based on output results from temperature sensors 52a of the respective driver ICs 52.

Under a predetermined condition, the stopper 66 stops driving of the driver IC 52 which is performed by the driver IC driver 64 and also stops driving of a conveyor motor (not shown) which drives the conveyor belt 8, in order to prevent thermal destruction of the driver IC 52. To be more specific, when the temperature detector 65 detects a temperature T equal to or higher than a predetermined maximum temperature Toff, the stopper 66 stops driving of the driver IC 52 and conveyance of the paper P under a condition that one driving unit of the driver IC 52 is completed, in other words, under a condition that a printing operation on the paper P is completed. Here, the maximum temperature Toff is set to a temperature lower than a temperature at which thermal destruction of the driver IC occurs.

After the stopper 66 stops driving of the driver IC 52 performed by the driver IC driver 64, the temperature estimator 67 estimates a temperature of the driver IC 52 increased in such a case that the driver IC driver 64 keeps driving the driver IC 52 for a period of time corresponding to continuous driving units, in other words, in such a case that a printing operation is performed on all of remaining papers P. To be more specific, the temperature estimator 67 estimates an increased temperature based on an average value of duty ratios of ejection waveforms included in drive signals which will be outputted by the driver IC 52 in performing a printing operation on all the remaining papers P.

When a predetermined condition is satisfied after the stopper 66 stops driving of the driver IC 52 performed by the driver IC driver 64, the restarter 68 restarts driving of the driver IC 52 which is performed by the driver IC driver 64 and also restarts driving of the conveyor motor (not shown) which drives the conveyor belt 8. To be more specific, when a temperature T of the driver IC 52 detected by the temperature detector 65 drops below a restart temperature Ton, the restarter 68 restarts driving of the driver IC 52 and driving of the conveyor motor. The restart temperature Ton is equal to or lower than a temperature value which is obtained by subtracting the increased temperature estimated by the temperature estimator 67 from the maximum temperature Toff. Among a plurality of preset temperatures, a temperature is selected for the restart temperature Ton. For example, in this embodiment, four restart temperatures Ton (Ton 1 to Ton 4) are preset. The restarter 68 determines the restart temperature Ton to be, among the restart temperatures Ton 1 to Ton 4, the temperature not higher than and closest to a temperature value which is obtained by subtracting an increased temperature estimated by the temperature estimator 67 from the maximum temperature Toff.

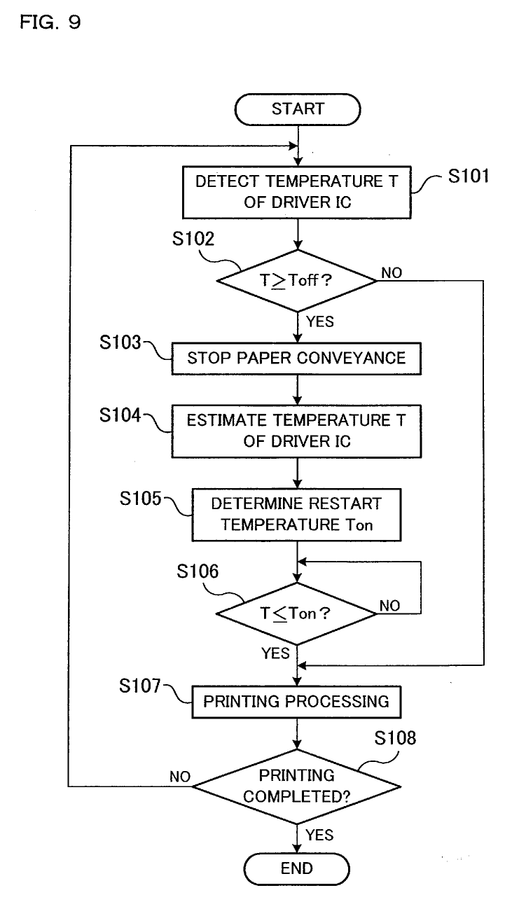

Next, an operation of the control unit 16 will be described with reference to FIG. 9. FIG. 9 is a flowchart showing an operation of the control unit 16. As shown in FIG. 9, when a printing starts, a processing goes to a step S101 (hereinafter abbreviated as S101, which applies to other steps), where the temperature detector 65 detects a temperature T of, among the driver ICs 52, a driver IC 52 having a highest temperature, based on output results from temperature sensors 52a of the respective driver ICs 52. Then, in S102, the stopper 66 determines whether the temperature detector 65 has detected a temperature T equal to or higher than the maximum temperature Toff, or not. When the temperature detector 65 has not detected a temperature T equal to or higher than the maximum temperature Toff (S102: NO), the processing goes to S107 where a printing operation is performed on a single paper P, that is, a printing operation for one driving unit is performed. When the temperature detector 65 has detected a temperature T equal to or higher than the maximum temperature Toff (S102: YES), the processing goes to S103 where the stopper 66 stops driving of the driver IC 52 performed by the driver IC driver 64 and also stops conveyance of a paper P. Like this, in this embodiment, the stopper 66 does not stop the driver IC 52 from outputting a drive signal while a printing operation on the paper P is being performed.

Then, in S104, the temperature estimator 67 estimates an increased temperature based on an average value of duty ratios of ejection waveforms included in drive signals which will be outputted by the driver IC 52 in performing a printing operation on all of remaining papers P. Then, in S105, the restarter 68 determines a restart temperature Ton by selecting, from the restart temperatures Ton1 to Ton4, a restart temperature Ton equal to or lower than a temperature value which is obtained by subtracting the increased temperature estimated by the temperature estimator 67 from the maximum temperature Toff. Then, in S106, the restarter 68 determines whether the temperature T of the driver IC 52 detected by the temperature detector 65 has become equal to or lower than the restart temperature Ton thus determined, or not. When the temperature T has not become equal to or lower than the restart temperature Ton (S106: NO), the processing stands by until the temperature T becomes equal to or lower than the restart temperature Ton. During this stand-by period, the driver IC 52 is cooled down. When the temperature T has become equal to or lower than the restart temperature Ton (S106: YES), the processing goes to S107 where the restarter 68 restarts driving of the driver IC 52 and conveyance of a paper P so that an printing operation on a next paper P is performed. When the printing operation is completed in S107, the processing goes to S108 where whether all printings have been completed or not is determined. When printings have not been completed (S108: NO), the processing goes to S101, and the above-described processing is repeated to perform a printing operation on a next paper P. When printings have been completed (S108: YES), the processing shown by the flowchart in FIG. 9 ends, and the printing is terminated.

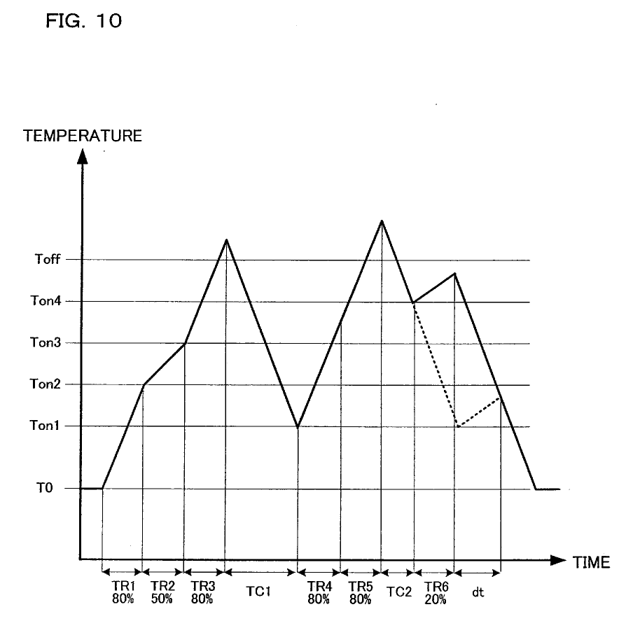

Next, with reference to FIG. 10, a description will be given to how a temperature of the driver IC 52 changes when a printing is performed. FIG. 10 is a graph showing a change in temperature of the driver IC 52 in a case where a printing operation is continuously performed on six papers P. In FIG. 10, an axis of ordinate represents a temperature T of the driver IC 52, an axis of abscissa represents time, and TO represents an initial temperature of the driver IC 52 in a standby state. TR1 to TR6 represent periods of time during which a printing operations is performed on the respective papers P. Values shown under the respective signs TR1 to TR6 represent average values of duty ratios of ejection waveforms included in drive signals which will be outputted by the driver IC 52 in performing a printing operation on the respective papers P. To be more specific, in performing a printing on a first, third, fourth, and fifth papers P, an average value of duty ratios of ejection waveforms included in drive signals which are outputted by the driver IC 52 is 80%. In performing a printing on a second paper P, an average value of duty ratios of ejection waveforms included in drive signals which are outputted by the driver IC 52 is 50%. In performing a printing on a sixth paper P, an average value of duty ratios of ejection waveforms included in drive signals which are outputted by the driver IC 52 is 20%. TC1 and TC 2 represent rest periods which are from when the stopper 66 stops driving of the driver IC 52 and conveyance of the paper P to when the restarter 68 restarts driving of the driver IC 52 and the conveyance of the paper P. For convenience of explanation, FIG. 10 shows a change in temperature of one driver IC 52. In the graph shown in FIG. 10, a broken line indicates a change in temperature of the driver IC 52 of a conventional ink-jet printer in which a restart temperature Ton is fixed at the restart temperature Ton 1.

As shown in FIG. 10, after a printing operation is performed on the first and second papers P, a temperature T of the driver IC 52 is not higher than the maximum temperature Toff. Accordingly, the stopper 66 does not stop driving of the driver IC 52 and conveyance of a paper P. As a consequence, the printing operation is continuously performed on the third paper P. After the printing operation is performed on the third paper P, a temperature T of the driver IC 52 is higher than the maximum temperature Toff. Accordingly, the stopper 66 stops driving of the driver IC 52 and conveyance of a paper P. At this time, the temperature estimator 67 estimates a temperature of the driver IC 52 increased in a case where a printing operation is performed on all of the remaining fourth to sixth papers P based on image data concerning images to be formed on the fourth to sixth papers P. To be more specific, the temperature estimator 67 estimates an increased temperature based on an average value of duty ratios of ejection waveforms included in drive signals which will be outputted by the driver IC 52 in performing a printing operation on the fourth to sixth papers P. The average value of the duty ratios is (80%+80%+20%)/3=60%. Then, the restarter 68 determines the restart temperature Ton, which is equal to or lower than a temperature value obtained by subtracting the increased temperature estimated by the temperature estimator 67 from the maximum temperature Toff, to be the restart temperature Ton1. Then, as the rest period TC1 elapses while driving of the driver IC 52 is being stopped, the driver IC 52 is cooled down so that a temperature T of the driver IC 52 detected by the temperature detector 65 becomes equal to or lower than the restart temperature Ton1. When a temperature T becomes equal to or lower than the restart temperature Ton1, the restarter 68 restarts driving the driver IC 52 and conveyance of the paper P, thereby starting a printing operation on the fourth paper P.

After the printing operation is performed on the fourth paper P, a temperature T of the driver IC 52 is equal to or lower than the maximum temperature Toff. Accordingly, the stopper 66 does not stop driving of the driver IC 52 and conveyance of a paper P. As a consequence, the printing operation is continuously performed on the fifth paper P. After the printing operation is performed on the fifth paper P, a temperature T of the driver IC 52 is higher than the maximum temperature Toff. Accordingly, the stopper 66 stops driving of the driver IC 52 and conveyance of a paper P. At this time, the temperature estimator 67 estimates an increased temperature based on an average value of duty ratios of ejection waveforms included in drive signals which will be outputted by the driver IC 52 in performing a printing operation on the sixth paper P. The average value is 20%. Then, the restarter 68 determines the restart temperature Ton to be the restart temperature Ton4. Then, as the rest period TC2 elapses while driving of the driver IC 52 is being stopped, a temperature T of the driver IC 52 becomes equal to or lower than the restart temperature Ton4. Therefore, the restarter 68 restarts driving the driver IC 52 and conveyance of a paper P, and thus a printing operation on the sixth paper P is completed. In a conventional ink-jet printer, a restart temperature Ton is fixed at the lowest restart temperature Ton 1. In such a case, the driver IC 52 is stopped until a temperature T of the driver IC 52 reaches the restart temperature Ton1, and then a printing operation on the sixth paper P is started. Therefore, in the conventional ink-jet printer, as compared with in the ink-jet printer 1, a printing completion time is elongated by a time dt.

In the above-described embodiment, the temperature estimator 67 estimates a temperature of the driver IC 52 increased when a printing operation is performed on all of remaining papers P, and the restarter 68 determines a restart temperature Ton which is equal to or lower than a temperature value obtained by subtracting the increased temperature estimated by the temperature estimator 67 from the maximum temperature Toff. This can prevent the driver IC 52 from being stopped too much. As a result, in a case where a printing operation is continuously performed on a plurality of papers P, lowering of a total printing speed can be suppressed while not stopping output of drive signals from the driver IC 52 during a printing operation being performed on a single paper P.

In this embodiment, the restarter 68 determines the restart temperature Ton selectively from the preset four restart temperatures Ton1 to Ton 4. Therefore, the restarter 68 can quickly determine the restart temperature Ton, because it is not necessary to calculate the restart temperature Ton.

In this embodiment, moreover, the temperature estimator 67 estimates an increased temperature based on an average value of duty ratios of ejection waveforms included in drive signals which will be outputted by the driver IC 52 in performing all remaining printing operations. Therefore, the temperature estimator 67 can estimates an increased temperature at high accuracy.

In this embodiment, in addition, a printing operation on one paper P is a driving unit. Therefore, a printing operation on one paper P is not stopped, and a high-quality printing can be made on the paper P.

[Modification]

Next, an ink-jet printer according to a modification of this embodiment will be described. In the ink-jet printer 1, the temperature estimator 67 estimates a temperature of the driver IC 52 increased when a printing operation is performed on all of remaining papers P, and the restarter 68 determines a restart temperature Ton, which is equal to or lower than a temperature value obtained by subtracting the increased temperature estimated by the temperature estimator 67 from the maximum temperature Toff, by selecting the restart temperature Ton from the four preset restart temperatures Ton1 to Ton 4. In this modification, however, a temperature estimator estimates a temperature of the driver IC 52 increased when a printing operation is performed only on a next paper P, and a restarter determines, as a restart temperature Ton, a temperature value which is obtained by subtracting the increased temperature estimated by the temperature estimator 67 from a maximum temperature Toff. That is, a restart temperature Ton is calculated individually for every driving unit. Therefore, when the restarter starts driving of the driver IC 52 and conveyance of a paper P and thus a printing operation on the next paper P is completed, a temperature of the driver IC 52 is approximately Toff, so that a stopper 66 stops driving of the driver IC 52 and the conveyance of a paper P.

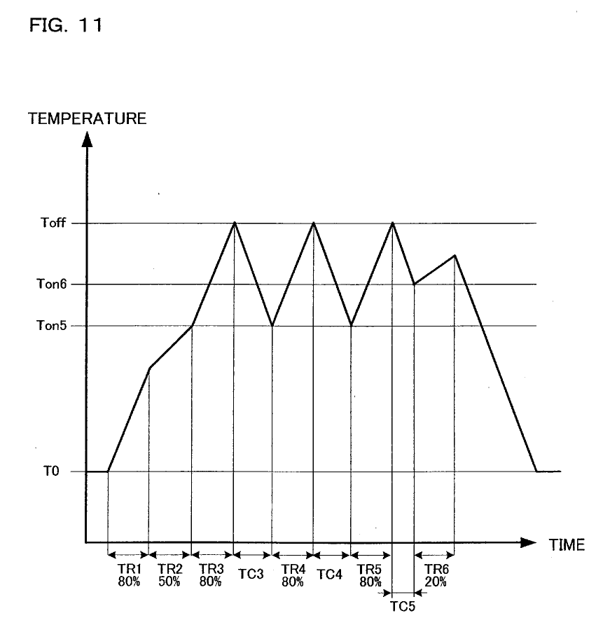

FIG. 11 is a graph showing a change in temperature of the driver IC 52 in a case where a printing operation is continuously performed on six papers P in the ink-jet printer according to the modification. An average value of duty ratios of ejection waveforms included in drive signals which are outputted by the driver IC 52 in performing a printing on each paper P is the same as those shown in FIG. 10. As shown in FIG. 11, after a printing operation is performed on the third paper P, a temperature T of the driver IC 52 is higher than the maximum temperature Toff. Accordingly, the stopper 66 stops driving of the driver IC 52 and conveyance of a paper P. At this time, the temperature estimator estimates an increased temperature based on an average value of duty ratios of ejection waveforms included in drive signals which are outputted by the driver IC 52 in performing a printing operation on the next fourth paper P. The average value is 80%. Then, the restarter determines a restart temperature Ton, which is a temperature value obtained by subtracting the increased temperature estimated by the temperature estimator from the maximum temperature Toff, to be a restart temperature Ton5. Then, as a rest period TC3 elapses while driving of the driver IC 52 is being stopped, the driver IC 52 is cooled down so that a temperature T of the driver IC 52 detected by the temperature detector 65 becomes equal to or lower than the restart temperature Ton5. When a temperature T becomes equal to or lower than the restart temperature Ton5, the restarter restarts driving the driver IC 52 and conveyance of the paper P, thereby starting a printing operation on the fourth paper P. The above-described processing is repeated for fifth and sixth papers P as well, and the printing operation is completed.

Like this, in this modification, the temperature estimator estimates a temperature of the driver IC 52 increased when a printing operation is performed on the next paper P, and the restarter determines a temperature value which is obtained by subtracting the increased temperature estimated by the temperature estimator 67 from the maximum temperature Toff, to be the restart temperature Ton. This can prevent the driver IC 52 from being stopped too much. As a result, in a case where a printing operation is continuously performed on a plurality of papers P, lowering of a total printing speed can be suppressed while not stopping output of drive signals from the driver IC 52 during a printing operation being performed on a single paper P.

In addition, once a temperature T of the driver IC 52 exceeds the maximum temperature Toff, then the driver IC 52 is stopped every time a printing operation is performed on a paper P. Accordingly, in one rest period, the driver IC 52 stays stopped for a shorter time. Therefore, ink in the nozzles 108 hardly dries up. As a result, the ink in the nozzles 108 is hardly thickened. This can suppress deterioration in ink ejection performance.

In the above-described embodiment, an increased temperature is estimated on an assumption that all remaining papers P or only a next paper P will be subjected to a printing operation. However, an object of the printing operation may be another predetermined number of papers P.

In the above-described embodiment, the temperature estimator 67 estimates an increased temperature based on an average value of duty ratios of ejection waveforms included in drive signals which will be outputted by the driver IC 52 in performing a next printing operation. However, it may be possible to estimate an increased temperature by another way, such as estimating it directly by image data stored in the image data memory 63.

In the above-described embodiment, a printing operation for forming an image on one paper P serves as one driving unit. However, this is not limitative. For example, it may be possible that, in a case where one paper P has a plurality of print regions which are spaced from each other by a margin with respect to the conveyance direction, a printing operation for each print region serves as one driving unit. It may also be possible that, in a case where a recording head is a serial-type head which scans in a direction perpendicular to the conveyance direction of a paper P, a printing operation including an arbitrary number of scannings serves as one driving unit.

In the above-described embodiment, the present invention is applied to the ink-jet printer 101. However, applications of the present invention are not limited thereto. The present invention is applicable to other apparatuses such as one for recording on a medium, one for forming a conductive pattern on a substrate, and the like, as long as a pulse pattern is generated without a stop in one or a plurality of driving units.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

What is claimed is:

1. A recording apparatus comprising:
a recording head which records an image on a recording medium;
a pulse generator which generates a pulse pattern for driving the recording head;
a temperature detector which detects a temperature of the pulse generator;
a driver which drives the pulse generator under a condition that the pulse generator is driven per driving unit which corresponds to a recording unit pertaining to a recording of the image;
a stopper which, when the temperature detector detects a temperature equal to or higher than a predetermined maximum temperature, stops the driver after driving of the pulse generator corresponding to one or a plurality of driving units is completed;
a temperature estimator which estimates a temperature of the pulse generator increased when the pulse generator is driven again by the driver, based on a pulse pattern which will be generated by the pulse generator thus driven again, on an assumption that the stopped driver is driven again and drives the pulse generator for a period of time corresponding to one or a plurality of driving units; and
a restarter which makes the driver restart driving the pulse generator when, after the driver is stopped, a temperature of the pulse generator detected by the temperature detector drops to a restart temperature which is equal to or lower than a temperature value obtained by subtracting the increased temperature from the maximum temperature.

2. The recording apparatus according to claim 1, wherein the restarter selects the restart temperature from a plurality of preset temperatures.

3. The recording apparatus according to claim 1, wherein the temperature estimator estimates the increased temperature based on an average value of a duty ratio of the pulse pattern.

4. The recording apparatus according to claim 1, wherein:
the recording head is opposed to the recording medium and extends in a direction perpendicular to a conveyance direction of the recording medium;
the recording head includes a passage unit in which formed are a plurality of individual ink passages each extending from a common ink chamber through a pressure chamber to a nozzle;
the recording head includes an ejection energy applier which applies ejection energy to the pressure chamber for ejecting an ink droplet from the nozzle; and
the pulse generator generates a pulse pattern for driving the ejection energy applier.

5. The recording apparatus according to claim 4, further comprising a conveyor mechanism which conveys the recording medium,
wherein:
when the temperature detector detects a temperature equal to or higher than the maximum temperature, the stopper stops conveyance of the recording medium performed by the conveyor mechanism after driving of the pulse generator corresponding to one or a plurality of driving units is completed; and
when a temperature detected by the temperature detector drops to the restart temperature, the restarter restarts conveyance of the recording medium performed by the conveyor mechanism.

6. A pulse generation controller comprising:
a pulse generator which generates a pulse pattern;
a temperature detector which detects a temperature of the pulse generator;
a driver which drives the pulse generator under a condition that a driving unit is a processing in which the pulse pattern should be generated without a stop;
a stopper which, when the temperature detector detects a temperature equal to or higher than a predetermined maximum temperature, stops the driver after driving of the pulse generator corresponding to one or a plurality of driving units is completed;
a temperature estimator which estimates a temperature of the pulse generator increased when the pulse generator is driven again by the driver, based on a pulse pattern which will be generated by the pulse generator thus driven again, on an assumption that the stopped driver is driven again and drives the pulse generator for a period of time corresponding to one or a plurality of driving units; and
a restarter which makes the driver restart driving the pulse generator when, after the driver is stopped, a temperature of the pulse generator detected by the temperature detector drops to a restart temperature which is equal to or lower than a temperature value obtained by subtracting the increased temperature from the maximum temperature.
